(19) United States
(12) Patent Application Publication
(10) Pub. No.: US 2004/0004405 A1
(43) Pub. Date: Jan. 8, 2004

(54) Constant force generator

(76) Inventor: Daniel Ausderau, Zurich (CH)

Correspondence Address: Welsh & Katz, Ltd., Eric D. Cohen, 22nd Floor, 120 South Riverside Plaza, Chicago, IL, 60606, US

(21) Appl. No.: 10/389,080

(22) Filed: Mar. 14, 2003

(30) Foreign Application Priority Data
Jul. 2, 2002 (CH) 1154/02

(51) Int. Cl. H02K 41/00

(52) U.S. Cl. 310/12; 310/15

(57) ABSTRACT

A constant force generator comprises a fixedly arranged part (10) and a part (11) arranged to be moveable in the axial direction relative to this fixedly arranged part (10). At least one of the two parts (10, 11) comprises a magnetically conductive region or a permanent magnetic region. At least the other part comprises a permanent magnetic region, whose magnetization is such that at least a portion of the magnetic flux (Φ) produced emerges from the permanent magnetic region at right angles to the axial direction of movement of the moveably arranged part (11), enters the magnetically conductive region, is guided therein, emerges from the magnetically conductive region again and runs back to the permanent magnetic region.

The invention relates to a constant force generator according to the independent patent claim.

When masses are moved in a direction differing from the horizontal direction, the force due to the weight plays a part, while in the case of a horizontal movement of the mass, the force due to the weight is unimportant. Disregarding frictional effects, therefore, in the case of a horizontal movement, power has to be applied by a drive system only in the acceleration and braking phases of a movement (in the case of a movement—assumed to be frictionless—at constant speed, no acceleration is required).

The situation is different in the case of moving the mass in a direction differing from the horizontal direction, in particular in the case of moving the mass in the vertical direction. In the latter case, the mass is constantly subject to the gravitational pull of the earth, that is to say the acceleration “g” of the earth, and therefore a constant force acts continuously on the mass. Even in the case of a stationary mass, a drive system here must therefore apply a corresponding counteracting force. In the case of electromagnetic drives—for example in the case of linear drives—this means that the linear motor must be energized continuously in order to keep a coupled mass stationary in one position. As a result of the continuous energization of the linear motor, losses (e.g. heat) are produced in the motor, which constitute an additional load on the motor (in addition to the load which arises during a movement of the mass). As a consequence, this means that the drive system—the linear motor here—has to be designed in such a way that, in addition to the power required to move the mass, it must also be possible to apply an additional constant power to compensate for the gravitational force. In applications of this type, therefore, a power which is disproportionately large in relation to the power required for the dynamic movement is needed merely in order to compensate for the gravitational force (due to the weight). This disadvantage has been met by various approaches, of which only a few are to be explained here.

One approach is based on the principle of elevators. A counterweight is provided, whose mass in a completely balanced system is exactly the same as the “load mass” to be accelerated (that is to say the mass actually desired to be accelerated). The complete mass actually to be accelerated is therefore doubled, and the drive has to be designed to be larger here, too.

A further approach is based on the use of mechanical springs to compensate for the gravitational force. Here, consideration is given in particular to specific spiral springs in which, within certain ranges of deflection, the restoring force is approximately constant and therefore the gravitational force can be compensated for. However, such springs can only be used for slow applications and small strokes, and in addition their lifetime is not very long.

A further approach is based on the pneumatic compensation of the gravitational force by means of a piston that can be displaced in a cylinder and to which a constant pressure is applied. For this purpose, firstly compressed air has to be provided and corresponding feed lines have to be provided and, in addition, a good seal has to be provided between piston and cylinder, resulting in high friction, and the seal also wears over time.

This is where the present invention is related to, its object being to compensate for the force due to the weight of a mass to be moved over a predetermined maximum stroke, that is to say to generate a corresponding counteracting force, but without the disadvantages described above.

This object is achieved by a constant force generator as characterized by the features of the independent patent claim. Particularly advantageous embodiments of the constant force generator according to the invention are evident from the features of the dependent patent claims. Particularly advantageous is the use of a constant force generator according to the invention in connection with a linear drive system.

In particular, the constant force generator comprises a fixedly arranged part a part arranged to be moveable in the axial direction relative to this fixedly arranged part. At least one of the two parts comprises a magnetically conductive (in particular ferromagnetic) or permanent magnetic region, and at least the other part comprises a permanent magnetic region. The magnetization of the permanent magnetic region is such that at least a portion of the magnetic flux generated emerges from the permanent magnetic region at right angles to the axial direction of movement of the moveably arranged part, enters the magnetically conductive region, is guided therein, emerges from the magnetically conductive region again and runs back to the permanent magnetic region.

The force acting on the moveable part as a result is used to compensate for the gravitational force (due to the weight), which is here produced only by magnetism, by which means complicated measures and also the disadvantages mentioned at the beginning can be avoided. In addition, the expenditure on construction of the constant force generator according to the invention is low.

In an advantageous exemplary embodiment of the constant force generator according to the invention, the permanent magnetic region has a magnetization which is aligned at right angles to the axial direction of movement. Therefore, at least a large portion of the emerging magnetic flux (virtually the entire magnetic flux, depending on the specific arrangement) can enter the magnetically conductive (in particular ferromagnetic) region, thus effecting a high (compensation) force.

The magnetization can be two-pole or else multi-pole (always integer multiples of two—there are no magnetic monopoles).

The permanent magnetic region can be provided on the moveable part and the magnetically conductive region on the fixedly arranged part, or vice versa.

In addition, both the moveably arranged part and the fixedly arranged part can have a permanent magnetic region, which can be advantageous in as much as this means that the (compensation) force can be increased.

In an advantageous exemplary embodiment of the constant force generator according to the invention, the fixedly arranged part can have a hollow profile in cross section, in which the moveable part is guided. The guide is advantageous in as much as it is possible in this way to prevent the moveable part being pulled completely against the fixedly arranged part as a result of the magnetic attraction, and therefore possibly no longer being moveable or being moveable only with great difficulty.

In a development of this exemplary embodiment of the constant force generator, the hollow profile is closed, which means that a symmetrical arrangement can be achieved, while in another development the hollow profile is open at least on one side, which can be advantageous in as much as that in such an asymmetrical arrangement loads can be coupled laterally to the moveable part (to be specific also in the region at the side of the hollow profile) and not just in the region of the moveable part which, in any case (even at maximum stroke) is located outside the hollow profile.

As already stated, one advantageous application of the constant force generator according to the invention is in a linear drive system having a drive unit which comprises a stator and an armature that can be moved relative to this stator, and in addition a constant force generator according to the invention as described above. The force due to the weight of a load coupled to the armature can then be compensated for by the constant force generator in non-horizontal applications, in particular in vertical applications, so that use can be made of a linear motor which is designed more or less for the dynamic movement of the load.

In this case, a linear drive system is particularly advantageous in which the moveable part of the constant force generator is connected to the armature of the linear drive, for example constitutes an extension of the armature of the linear drive.

If the connection is designed to be releasable, even the drive system can be connected to an appropriately designed constant force generator, depending on the “load mass” to be moved.

In a development of the linear drive system, two constant force generators are provided whose fixedly arranged parts are connected to each other and which together form a common fixed part, in which the moveable parts of the constant force generator are guided. The two moveable parts are connected to each other by a connecting piece, for example a plate. The armature of the drive unit is also connected to this connecting piece. This constructional configuration prevents the armature of the linear motor being able to rotate owing to transverse forces or moments acting on the load mass.

Further advantageous configurations emerge from the following description of exemplary embodiments of the invention with the aid of the drawing, in which:

FIGS. 1-4 show the basic mode of action of the constant force generator according to the invention using a diametrically magnetized element and an iron core, in various relative positions,

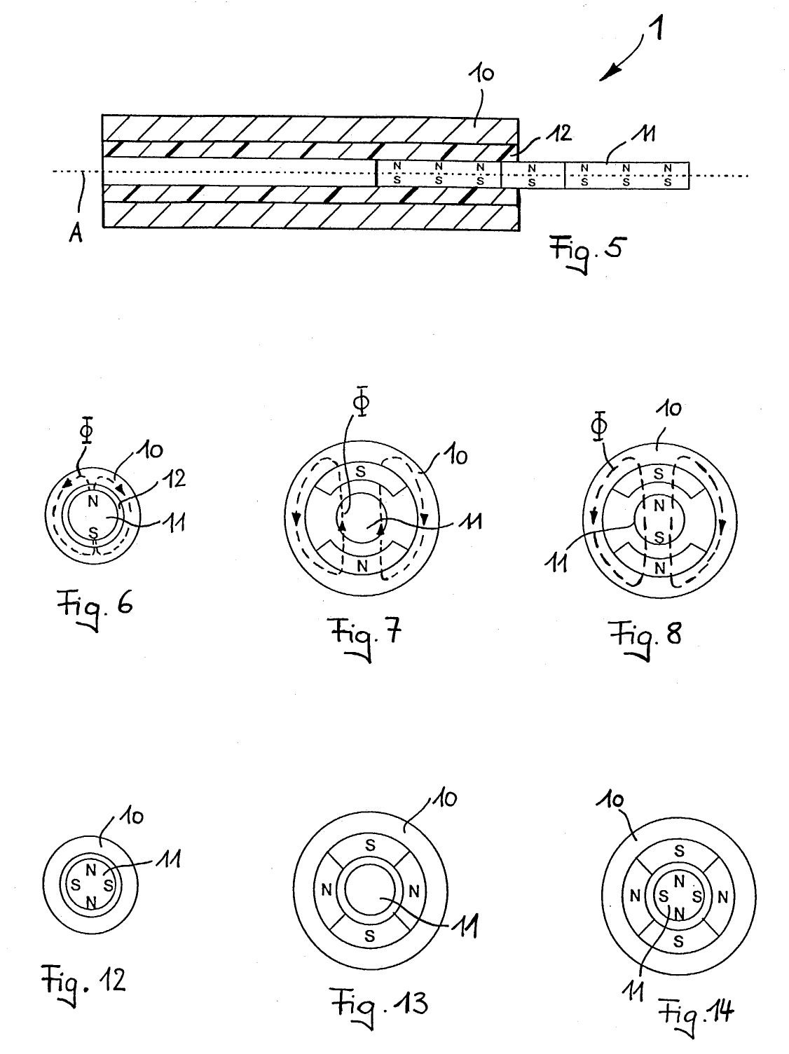

FIG. 5 shows an exemplary embodiment of a constant force generator having a circularly cylindrical, magnetically conductive fixed part and a diametrically magnetized part that can be moved relative thereto, in longitudinal section,

FIGS. 5a-5d show the exemplary embodiment of the constant force generator from FIG. 5 with various relative positions of moveable part and fixed part,

FIG. 6 shows the exemplary embodiment of the constant force generator from FIG. 5 in cross section,

FIG. 7 shows an exemplary embodiment of the constant force generator with a circularly cylindrical fixed part with permanent magnetization and a magnetically conductive part that can be moved relative thereto,

FIG. 8 shows an exemplary embodiment of the constant force generator with a circularly cylindrical fixed part with permanent magnetization and a part that can be moved relative thereto with diametrical magnetization,

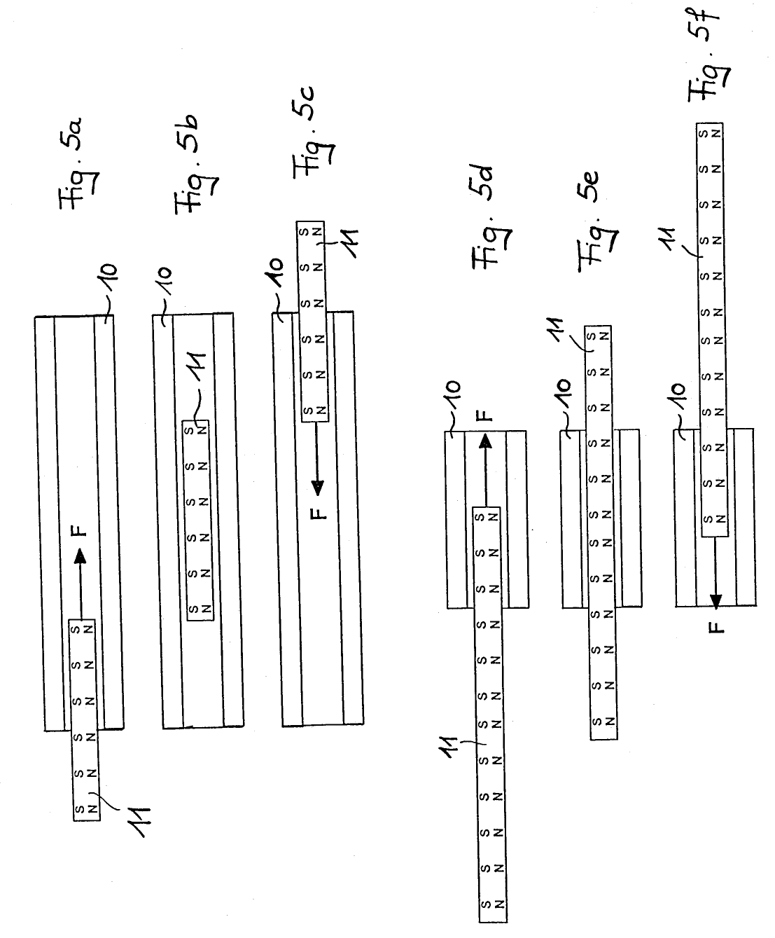

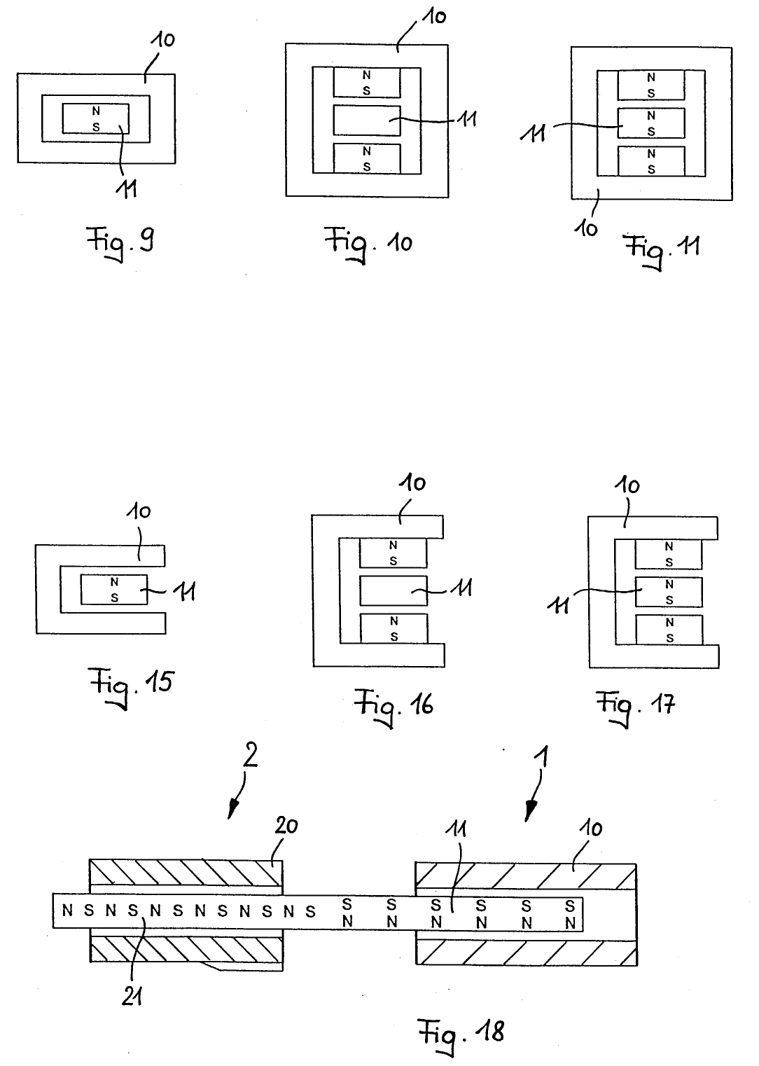

FIGS. 9-11 show exemplary embodiments of the constant force generator with a rectangular cross section, which otherwise corresponds to the exemplary embodiments according to FIGS. 6-8,

FIGS. 12-14 show exemplary embodiments of the constant force generator according to FIGS. 6-8 but with multi-polar magnetization,

FIGS. 15-17 show exemplary embodiments of the constant force generator with a rectangular cross section corresponding to the exemplary embodiments according to FIGS. 9-11 but open on one side,

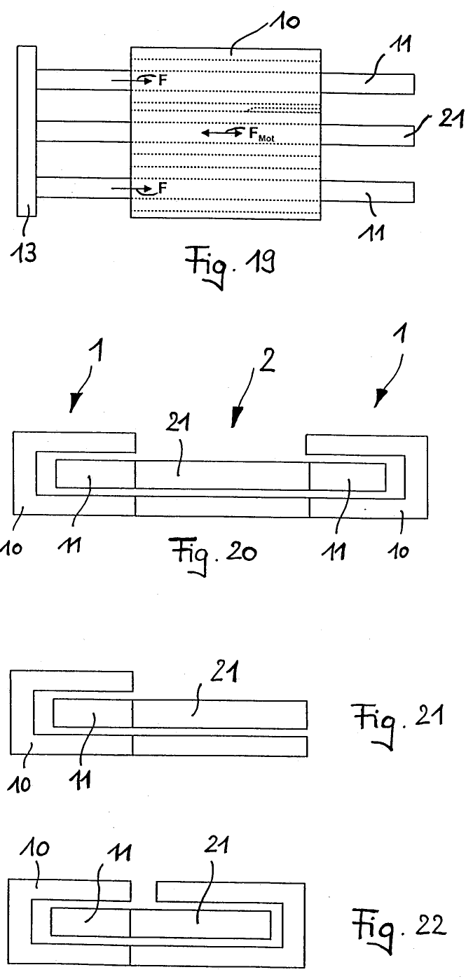

FIG. 18 shows an example of the application of the constant force generator in combination with a linear drive (schematically),

FIG. 19 shows a further example of the application of the constant force generator in combination with a linear drive with the armature secured against rotation (H-form),

FIGS. 20-22 show further exemplary embodiments of the constant force generator, in which the moveable part of the constant force generator is connected to the armature of a linear drive.

By way of introduction, it should be recorded that the following description of the exemplary embodiments using the individual figures is in principle carried out with the aid of horizontal arrangements, since the figures can be arranged in a more space-saving manner in this way. The actual application is, however, conceived precisely for non-horizontal arrangements, since in these applications the force due to the weight of a load mass certainly has to be compensated, and it is definitely in principle the case that it is precisely this weight-force compensation (or at least very substantial proportions thereof) which is to be performed by the constant force generator.

Referring to FIGS. 1-4, the basic mode of action of the constant force generator 1 according to the invention is to be explained first. For this purpose, the figures illustrate a U-shaped iron core (iron is a ferromagnetic and therefore magnetically very highly conductive material) as the fixed part 10 and a diametrically (permanent) magnetized element 110 of a moveable part 11 (see FIG. 4), which is sufficient to explain the functional principle. In FIGS. 1-3, the diametrically magnetized element 110 is located in three different characteristic positions, which will be considered in more detail below.

In FIG. 1, the magnetized element 110 is arranged completely in the region of the iron core 10. The magnetic flux Φ emerging from the magnetized element 110 of the moveable part 11 enters the iron core 10, is guided in this back as far as the magnetized element 110, by which means the magnetic circuit is closed. For simplicity, it will be assumed here that the attraction forces between the magnetized element 110 and the two limbs of the iron core 10 are precisely equal here. Virtually the entire magnetic flux emerging from the magnetized element 110 enters the iron core 10 and is led back in the latter to the magnetized element 110. No force acts on the magnetized element 110 in the longitudinal direction (that is to say to the left or to the right in FIG. 1).

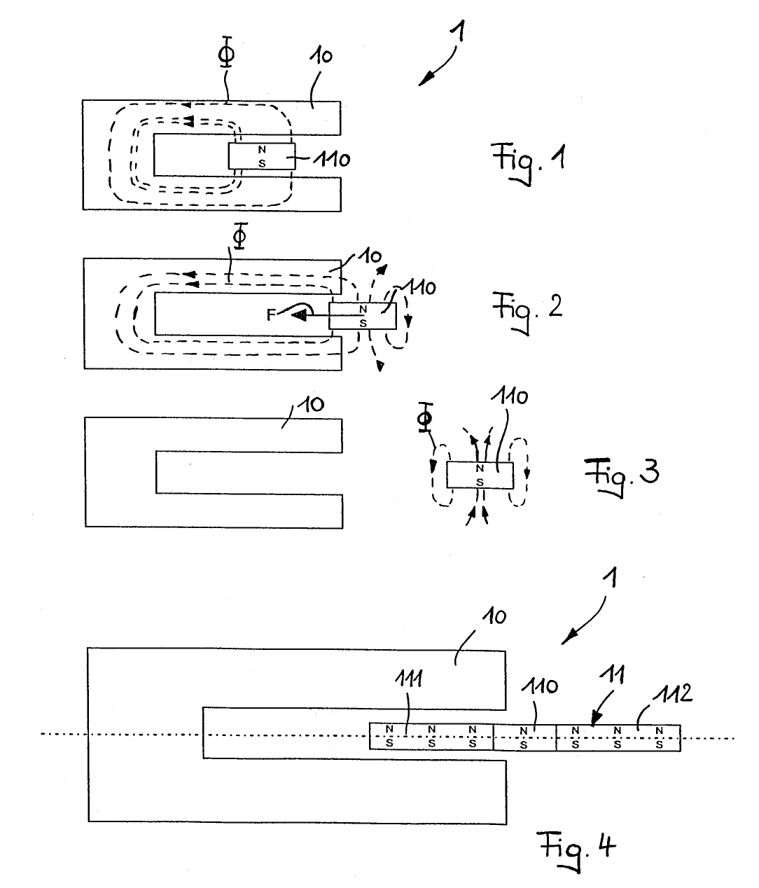

In FIG. 2, the magnetized element 110 is arranged such that the magnetic flux emerging from the element 110 just begins to enter the iron core 10 (at the left-hand end in FIG. 2). A force F which points in the direction illustrated in FIG. 2 acts on the magnetized element 110 and the magnetized element 110, so to speak, is pulled “into the iron core”. Once the magnetized element 110 has penetrated completely into the iron core 10, the magnetic flux emerging from the element 110 is guided completely in the iron core 10, and the situation again corresponds to the situation as was explained using FIG. 1. In order that the magnetized element 110 remains at rest and is not pulled further into the iron core 10, a force due to weight of identical magnitude and acting on a mass could then act at the other end of the element 110 (at the right-hand end in FIG. 2), for which purpose the illustration in FIG. 2 would have to be imagined as rotated through 90°, for example, since FIG. 2 concerns a horizontal arrangement.

Finally, in FIG. 3 the magnetized element 110 is arranged in such a way that the magnetic flux emerging from the element 110 cannot enter the iron core 10 at all. In this case, no force acts on the element 110 either.

However, in the situation shown in FIG. 2, the force F acting on the magnetized element 110 is not always the same as is desired to compensate for a gravitational force (due to a weight. However, this is because in FIG. 2 (and also in FIG. 1 and FIG. 3), only a small detail of a moveable part 11 of a constant force generator 1 according to the invention is illustrated in order to be able to explain better the various situations and therefore the function.

If a longer permanent magnetic region of the moveable part 11 is considered in FIG. 4, then it will be seen immediately that the piece 111 of the permanent magnetic region of the moveable part 11 that has already penetrated into the iron core 10 does not bring about any forces in the longitudinal direction (that is to say to the left or right in FIG. 4), but corresponds to the situation in FIG. 1. Adjacent to this, it is possible to see that element 110 of the permanent magnetic region which results in a force F, corresponding to the situation in FIG. 2. This is followed by a piece 112, which likewise does not bring about any forces in the longitudinal direction, but corresponds to the situation in FIG. 3.

As already explained, the force on the individual magnetized element 110 as it enters the iron core 10 (see situation in FIG. 2) is not constant (because of the only short longitudinal extent of the element 110). In the case of a total permanent magnetic region of a moveable part 11, as illustrated in FIG. 4, it is the case, on the other hand, that the entire permanent magnetic region (has the same magnetization and therefore over a corresponding length). If, then, the permanent magnetic region of the moveable part 11 is imagined to be subdivided into many individual identically magnetized elements 110, then there is always exactly the same quantity of magnetic flux Φ, which brings about the force F, since that portion of the magnetic flux which is lost to the formation of the force F as the permanent magnetic region of the moveable part 11 enters further—in FIG. 4 this is that proportion which passes completely between the limbs of the iron core 10 during the further entry of the moveable part in the direction to the left and therefore no longer contributes to the formation of the force F—is shifted after it again from the rear (that is to say from the right in FIG. 4), so that the quantity of magnetic flux Φ contributing to the formation of the force F, and therefore the force F, remains constant. Of course, this applies not only during a movement of the permanent magnetic region of the moveable part 11 in the direction “into the iron core 10” (that is to say to the left in FIG. 4), but also during a movement of the permanent magnetic region of the part 11 in the direction “out of the iron core” 10 (that is to say to the right in FIG. 4).

FIG. 5 now illustrates an exemplary embodiment of a constant force generator 1 having a circularly cylindrical, magnetically conductive fixed part 10 (corresponding to the iron core) and a diametrically magnetized part that can be moved relative thereto, in longitudinal section. In this case, magnetically conductive is to be understood to mean the property of guiding the incoming magnetic flux more or less completely within the material. The fixed part 10 is hollow cylindrical. Furthermore, the permanent magnetic region of the moveable part 11 can be seen, which is likewise circularly cylindrical. Since it is in practice only possible with difficulty to form the moveable part 11 so that it is always moved along the longitudinal axis A in an accurately balanced manner, the moveable part 11 or its permanent magnetic region is guided in the fixed part 10. In the event of the smallest deviation from the (unstable) balanced state, otherwise the moveable part 11 or its permanent magnetic region would be pulled against the inner wall of the fixed part. Here, the guidance of the moveable part 11 or of its permanent magnetic region is implemented by a sliding inlay 12 (for example of polyethylene) being provided (illustrated as exaggeratedly “thick” in FIG. 5), which guides the moveable part 11 or its permanent magnetic region, there being slight clearance between the moveable part 11 and the sliding inlay 12. Here, too, the moveable part 11 is of course pulled out of the (unstable) balanced position against the sliding inlay, but this can be tolerated because of the low friction between moveable part 11 and sliding inlay 12. A view of the exemplary embodiment which is illustrated in longitudinal section in FIG. 5 can be seen in FIG. 6, from which the circularly cylindrical form can easily be seen.

If it is imagined in FIG. 5 that like-named magnetic poles on the moveable part 11 and on the fixed part 10 come to lie opposite each other, the moveable part would of course not be pulled into the fixed part but repelled. If the moveable part 11 is therefore moved into the fixed part by a specific distance, then a gravitational force acting counter to the force acting in repulsion can be likewise compensated for. This is also the case in rectangular cross sections, it possibly being necessary in the case of round cross sections for the moveable part to be guided in a manner to be fixed against rotation, so that it does not attempt to align itself by rotation such that it comes to lie opposite unlike-named poles. In the case of rectangular cross sections, the normal sliding guide is sufficient for this purpose, since rotation is prevented there by the rectangular shape.

FIGS. 5a-5f again illustrate the exemplary embodiment of the constant force generator from FIG. 5 in various relative positions of the moveable permanent magnetic part 11 and fixed hollow cylindrical (and magnetically conductive) part 10, it being possible to see in FIGS. 5a-5c a short moveable permanent magnetic part 11 and a fixed hollow cylindrical part 10 which is long in relation thereto. Here, the illustration of the sliding insert has been omitted. It can be seen that, when the moveable part 11 has penetrated completely into the fixed part 10 (FIG. 5b), no force acts on the moveable part 11, while in the two other relative positions (FIG. 5a, FIG. 5c), in each case a force F acts, as shown in the corresponding figures.

The same applies with regard to FIGS. 5d-5f, in which in each case a relatively long moveable part 11 and a relatively short fixed hollow cylindrical part 10 are illustrated. Here, too, it is easy to see that when the moveable part 11 has penetrated completely, no force acts on the moveable part 11 (this applies even if the moveable part has not penetrated symmetrically but nevertheless completely into the hollow cylindrical part 10).

If FIGS. 5a-5f are considered, it is possible to see that such a constant force generator can also be used as a braking or acceleration element, in particular for cyclic movements. For example, if the moveable part 11 in FIG. 5a is initially accelerated in the direction into the fixed part (to the right in FIG. 5a) and then passes through the fixed part 10 in FIG. 5b, then it will be braked as it emerges from the fixed part (FIG. 5c), specifically because a force acts counter to the direction of movement.

A further exemplary embodiment of the constant force generator is illustrated in FIG. 7. In this exemplary embodiment, the fixed part 10 is likewise circularly cylindrical and hollow cylindrical. However, the permanent magnetization is here provided on the fixed part 10. The part 11 which can be moved relative to the fixed part 10 is produced from a magnetically conductive material. In principle, this is the same principle as in FIG. 6, except that the permanent magnetization is here provided on the fixed part 10. The illustration of the sliding inlay has been omitted. The permanent magnets can be imagined as having diametrical magnetization in FIG. 7, the magnetic south pole pointing inward in the upper permanent magnet (as illustrated) and the magnetic north pole (not illustrated) pointing outward (there are no magnetic monopoles). The converse applies in the lower permanent magnet. For reasons of better clarity of the illustration, in FIG. 7 the magnetic pole respectively pointing outward has been omitted.

A further exemplary embodiment of the constant force generator is illustrated in FIG. 8. Here, too, the fixed part 10 is circularly cylindrical and hollow cylindrical and has permanent magnetization, similar to that in the exemplary embodiment according to FIG. 7. However, the moveable part 11 is also provided with a permanent magnetization that is complementary to the permanent magnetization of the fixed part 10. With this exemplary embodiment, with otherwise identical magnetization, the force F produced is increased (higher magnetic flux (Φ).

The exemplary embodiments of the constant force generator shown in FIGS. 12-14 correspond to those according to FIGS. 6-8, but with multi-pole magnetization, by which means the force F can be increased further (with otherwise identical magnetization).

The exemplary embodiments of the constant force generator shown in FIGS. 9-11 have rectangular cross sections but otherwise correspond to the exemplary embodiments according to FIGS. 6-8. The illustration of the sliding inlay has also been omitted for reasons of better clarity. Multi-pole magnetizations could also be provided in rectangular cross sections, in a way analogous to the round cross sections.

In principle, other cross-sectional forms (for example elliptical, polygonal, etc.) than those shown could also be used for the fixed part 10 and the moveable part 11.

FIGS. 15-17 show further exemplary embodiments of the constant force generator, which likewise have a rectangular cross-sectional form, that is to say are substantially similar to the exemplary embodiments in FIGS. 9-11, but in which the fixed part 10—as distinct from the closed exemplary embodiments explained previously—is open on one side (to the right here) This makes it possible to couple loads even in this region of the moveable part (and not only in a region which with certainty no longer penetrates into the fixed part, even at maximum stroke). Again, the illustration of the guide for the moveable part 11 has been omitted.

FIG. 18 now illustrates an exemplary embodiment of the constant force generator in the form of a linear drive system, which comprises the constant force generator 1 in combination with a linear drive 2, and which is illustrated schematically. It is possible to see on one side the linear drive 2 with stator 20 and armature 21, and also the constant force generator 1 with fixed part 10 and moveable part 11. The armature 21 of the linear drive is connected to the moveable part 11, it being possible for this connection to be fixed or detachable. If such a drive system is used in vertical operation, then the force due to the weight of a load coupled to the armature 21 can be compensated for by the constant force generator 1, so that the linear drive needs to be designed only for the loading arising from the dynamic movement of the load. In the case of a detachable connection of the armature 21 to the moveable part 11 of the constant force generator 1, various drives 2 can be combined with various constant force generators 1, which is particularly advantageous since the entire drive system can be matched well to the respective application.

FIG. 19 shows a further exemplary application of the constant force generator in combination with a linear drive, the armature 21 of the linear drive being secured against rotation here. The armature 21 of the linear drive in FIG. 19 is arranged in the center of two moveable parts 11 belonging to the constant force generator. In this case, the fixed part 10 can be imagined as a part composed of two individual fixed parts (which, for example, have a H-shaped outer shape or else another shape). Not only can the two moveable parts 11 be guided in this fixed part 10 but also the armature 21 of the linear drive. The two moveable parts 11 are connected to each other by a connecting piece 13—here in the form of a plate. The armature 21 of the linear drive is also connected to this connecting piece 13. The load mass can, for example, be coupled to the connecting piece 13, but could also be coupled to the other end of the armature 21 of the linear drive. Security against rotation and good guidance of the (linear) movement is ensured in both cases. In FIG. 19, F in each case designates the force of the constant force generator, with which the force due to the weight of a load mass (in the event of a direction of movement differing from the horizontal) can be compensated for, while F_{Mot} designates the force that can be generated by the linear drive for the dynamic movement of the load mass—the force due to the weight of the load mass is of course to be compensated for by the constant force generator.

FIGS. 20-22 show three further exemplary embodiments of a linear drive system 2, which are coupled to at least one constant force generator 1. In this case, the armature 21 of the linear drive is in each case connected to the moveable part 11 of the constant force generator or to the moveable parts 11 of the constant force generators, but the moveable parts 11 are in each case coupled laterally (the armature 21 moves out of the plane of the paper or into the plane of the paper).

In the exemplary embodiment according to FIG. 20, the armature 21 of the linear drive is connected on both sides to the moveable parts 11 of two constant force generators, which in principle are constructed in the same way as those which have been explained using FIG. 15. This allows a higher gravitational force to be compensated for, with an otherwise identical design, since, so to speak, two constant force generators are provided. The arrangement additionally has the advantage that it is symmetrical.

In the exemplary embodiment according to FIG. 21, on the other hand, the armature 21 of the linear drive is connected only on one side to the moveable part 11 of a constant force generator, so that here there is not a symmetrical arrangement. On the other hand, the load mass can also be connected directly laterally to the armature 21 of the linear drive. The exemplary embodiment according to FIG. 22 is similar to that from FIG. 21, but here the armature 21 of the linear drive is accessible only from above.

The moveable parts 11 described previously can be constructed as rods or solid sections which have a corresponding diametrical permanent magnetization, but can also be constructed as hollow sections, for example, and can be filled with appropriately diametrically magnetized magnets (for example disks or cylindrical pieces). In the latter case, care must of course be taken that the hollow sections are produced from a material which is not magnetically conductive (or conducts only poorly, for example aluminum or corresponding alloyed steels) in order that the magnetic flux is not already fed back in the hollow section of the moveable part 11. It can also be imagined that the magnitude of the forces on the moveable part 11 can be varied, for example by parts of the magnetic circuit (for example the magnets in the fixed part 10 in FIG. 8) being displaced or rotated. In this way, the forces on the moveable part can be “adjusted” to a certain extent.

1. A constant force generator (1) comprising a fixedly arranged part and a part (11) arranged to be moveable in the axial direction relative to this fixedly arranged part (10), at least one of the two parts (10, 11) comprising a magnetically conductive region or a permanent magnetic region, and at least the other part comprising a permanent magnetic region whose magnetization is such that at least a portion of the magnetic flux (Φ) produced emerges from the permanent magnetic region at right angles to the axial direction of movement of the moveably arranged part (11), enters the magnetically conductive region, is guided therein, emerges from the magnetically conductive region again and runs back to the permanent magnetic region.

2. A constant force generator according to claim 1, wherein the permanent magnetic region has a magnetization which is aligned at right angles to the axial direction of movement.

3. A constant force generator according to claim 2, wherein the magnetization is multi-polar.

4. A constant force generator according to any one of the preceding claims, wherein the permanent magnetic region is provided on the moveable part (11) and the magnetically conductive region is provided on the fixedly arranged part (10).

5. A constant force generator according to any one of claims 1 to 3, wherein the permanent magnetic region is provided on the fixed part (10) and the magnetically conductive region is provided on the moveable part (11).

6. A constant force generator according to any one of the preceding claims, wherein both the moveably arranged part (11) and the fixedly arranged part (10) have a permanent magnetic region.

7. A constant force generator according to any one of the preceding claims, wherein the fixedly arranged part (10) has a hollow profile in cross section, in which the moveable part (11) is guided.

8. A constant force generator according to claim 7, wherein the hollow profile is closed.

9. A constant force generator according to claim 7, wherein the hollow profile is open at least on one side.

10. A linear drive system having a drive unit (2) which comprises a stator (20) and an armature (21) which can be moved relative to said stator (20), and further having a constant force generator (1) according to any one of the preceding claims.

11. The linear drive system according to claim 10, wherein the moveable part (11) of the constant force generator (1) is connected to the armature (21) of the linear drive (2).

12. The linear drive system as claimed in claim 11, in which two constant force generators (1) are provided, whose fixedly arranged parts are connected to each other and together form a common fixed part (10), in which the moveable parts (11) of the constant force generator (1) are guided, and in which, moreover, the two moveable parts (11) are connected to each other by a connecting piece (13), for example a plate, to which connecting piece (13) the armature (21) of the drive unit (2) is also connected.
